(19) United States
(12) Patent Application Publication
(10) Pub. No.: US 2013/0278834 A1
(43) Pub. Date: Oct. 24, 2013

(54) DISPLAY POWER REDUCTION USING EXTENDED NAL UNIT HEADER INFORMATION

(71) Applicant: SAMSUNG ELECTRONICS CO., LTD., Suwon-si (KR)

(72) Inventors: Zhan Ma, Dallas, TX (US); Mian Dong, Dallas, TX (US); Felix C.A. Fernandes, Plano, TX (US); Sungoh Hwang, Yong-in-Shi (KR)

(73) Assignee: SAMSUNG ELECTRONICS CO., LTD., Suwon-si (KR)

(21) Appl. No.: 13/793,352

(22) Filed: Mar. 11, 2013

Related U.S. Application Data
(60) Provisional application No. 61/636,549, filed on Apr. 20, 2012.
(60) Provisional application No. 61/636,543, filed on Apr. 20, 2012.
(60) Provisional application No. 61/636,561, filed on Apr. 20, 2012.

(51) Int. Cl. H04N 5/63

(52) U.S. Cl. CPC H04N 5/63
USPC 348/730

(57) ABSTRACT

Segments for a video are transmitted in payload units with an extended network abstraction layer unit (NALU) header within which is embedded display adaptation information that may be employed to control display brightness and thereby reduce power consumption during display of the respective segment. The display adaptation information includes at least a maximum pixel brightness that may be used to scale pixel brightness to maximum and correspondingly reduce backlighting for liquid crystal displays, or to adjust the supply voltage for OLED displays. The display adaptation information may optionally include a minimum pixel brightness, a pixel histogram step size, and an indicator of scaling method.

This application hereby incorporates by reference U.S. Provisional Patent Application No. 61/636,549, filed Apr. 20, 2012, entitled “DISPLAY POWER REDUCTION USING EXTEND NAL UNIT HEADER INFORMATION,” U.S. Provisional Patent Application No. 61/636,543, filed Apr. 20, 2012, entitled “DISPLAY POWER REDUCTION USING EXTEND SEI INFORMATION,” AND U.S. Provisional Patent Application No. 61/636,561, filed Apr. 20, 2012, entitled “PERCEPTUAL LOSSLESS DISPLAY POWER REDUCTION.”

### TECHNICAL FIELD

The present disclosure relates generally to reduction of energy consumption in wireless mobile communication devices and, more specifically, to content-based display adaptation control for video content displayed on a wireless mobile communication device.

### BACKGROUND

In recent years, display resolution on mobile devices has advanced significantly, to where 720p or even higher super liquid crystal display (LCD) or OLED organic light emitting diode (OLED) displays are or soon will be mainstream for smart phones and tablets. However, such high display resolution requires much more energy for rendering, especially for video where high frequency frame buffering and display panel refresh are indispensable.

For LCD displays, power consumption is a monotonic function of the backlighting brightness level; for OLED displays, power consumption is controlled by the supply voltage as well as the display content itself. While a brightness control is already implemented on some mobile devices, those controls typically must be adjusted prior to issuing a new job—that is, before starting playback of a video. For example, brightness may be set at 100%, 50%, or even 25% prior to watching a video, but cannot be changed dynamically without interrupting playback of the video. In addition, since power consumption is determined by the supply voltage and input image for OLED displays, current implementations do not provide a mechanism for adapting the voltage.

There is, therefore, a need in the art to improve mobile device displays by allowing either LCD display backlighting brightness or OLED supply voltage to be adapted according to the content being displayed, saving significant display energy.

### SUMMARY

Segments for a video are transmitted in payload units with an extended network abstraction layer unit (NALU) header within which is embedded display adaptation information that may be employed to control display brightness and thereby reduce power consumption during display of the respective segment. The display adaptation information includes at least a maximum pixel brightness that may be used to scale pixel brightness to maximum and correspondingly reduce backlighting for liquid crystal displays, or to adjust the supply voltage for OLED displays. The display adaptation information may optionally include a minimum pixel brightness, a pixel histogram step size, and an indicator of scaling method.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, where such a device, system or part may be implemented in hardware that is programmable by firmware or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high level diagram illustrating a network within which devices may implement dynamic, content-based display adaptation and corresponding power reduction according to one or more embodiments of the present disclosure;

FIG. 1A is a front view of wireless device from the network of FIG. 1 within which dynamic, content-based display adaptation and corresponding power reduction may be implemented according to one embodiment of the present disclosure;

FIG. 1B is a high level block diagram of the functional components of the wireless device illustrated in FIG. 1A;

FIG. 2 is a diagram illustrating NALU headers within which may be embedded display adaptation information used for dynamic, content-based display adaptation and corresponding power reduction according to one embodiment of the present disclosure;

FIGS. 3A and 3B illustrate display adaptation preserving brightness using display adaptation information embedded within NALU headers for dynamic, content-based display adaptation and corresponding power reduction according to one embodiment of the present disclosure;

FIGS. 4A and 4B illustrate extended NALU header insertion within a video data bitstream for dynamic, content-based display adaptation and corresponding power reduction according to one embodiment of the present disclosure;

FIG. 5 is a high level flow diagram for a process of encoding video using extended NALU header insertion for dynamic, content-based display adaptation and corresponding power reduction according to one embodiment of the present disclosure; and

FIG. 6 is a high level flow diagram for a process of video decoding and display based on extended NALU headers inserted for dynamic, content-based display adaptation and corresponding power reduction according to one embodiment of the present disclosure.

### DETAILED DESCRIPTION

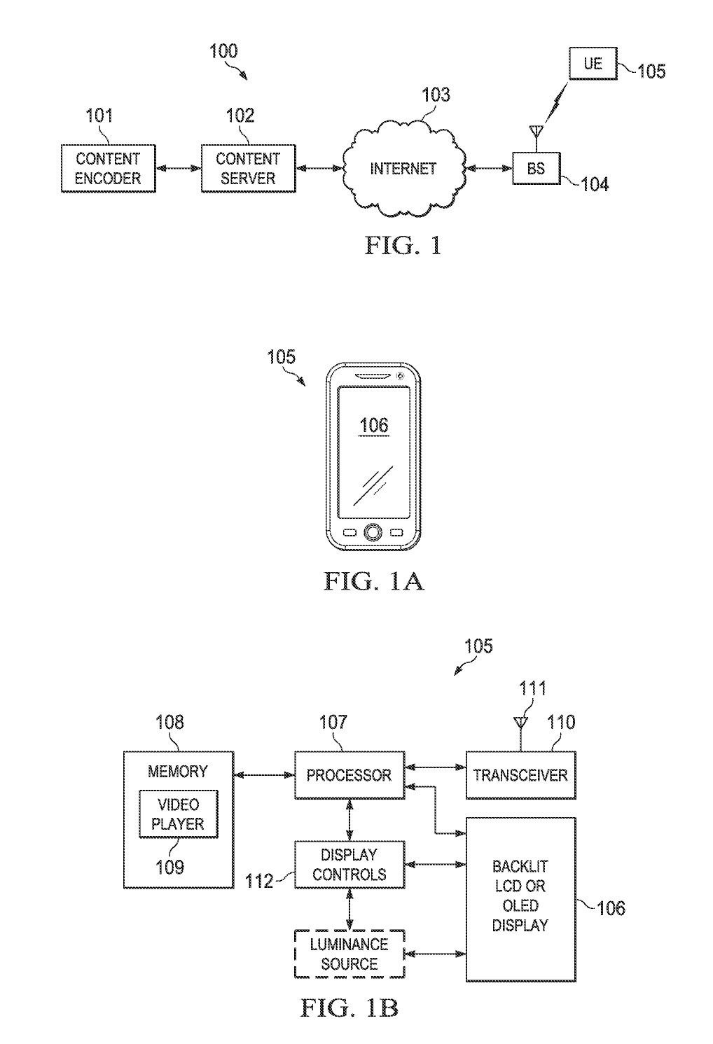

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The metadata used for display adaptation can be embedded into the video stream as the extended NALU (network abstraction layer unit) header.

In the present disclosure, display adaptation is embedded within the video content information using an extended Network Abstraction Layer (NAL) Unit (NALU) header, which is then parsed at the decoder to help with display power reduction. For LCD displays, the display brightness is adjusted, while for OLED displays, the display supply voltage is adapted. Elements in this extended NALU header can be derived at the encoder during video encoding.

Display adaptation is defined by enabling a NALU header that can be inserted into stream frame by frame, or group of pictures (GOP) by GOP, scene by scene, or even time interval by time interval, depending on the underlying applications and the hardware capability. By comparison with a frame-level solution, GOP, a scene or time interval based approach requires less overhead for message insertion. For processors that do not support high-frequency display adaptation, e.g., every 33 millisecond (ms) for a 30 Hertz (Hz) video, GOP, scene or time interval based schemes are better than a frame based solution. Nonetheless, the concept is explained herein primarily using a frame level solution.

FIG. 1 is a high level diagram illustrating a network within which devices may implement dynamic, content-based display adaptation and corresponding power reduction according to one or more embodiments of the present disclosure. The network 100 includes a content encoder data processing system 101 including an encoder controller configured to encode video content in accordance existing procedures, but with display adaptation information embedded within NALU header(s) as described in further detail below. The content encoder 101 is communicably coupled to (or alternatively integrated with) a content server data processing system 102, which delivers video content to user devices. The content server 102 is coupled by a communications network, such as the Internet 103 and a wireless communications system including a base station (BS) 104, for delivery of the video content to a user device 105, which may also be referred to as user equipment (UE) or a mobile station (MS). As noted above, the user device 105 may be a “smart” phone or tablet device capable of functions other than wireless voice communications, including at least playing video content. Alternatively, the user device 105 may be a laptop computer or other wireless device having an LCD or OLED display and benefitting from dynamic, content-based display power reduction during playback of videos, such as any device that is primarily battery-powered during at least periods of typical operation.

FIG. 1A is a front view of wireless device from the network of FIG. 1 within which dynamic, content-based display adaptation and corresponding power reduction may be implemented according to one embodiment of the present disclosure, and FIG. 1B is a high level block diagram of the functional components of that wireless device. User device 105 is a mobile phone and includes a backlit LCD (which includes the optional luminance source depicted in FIG. 1B) or OLED display 106. A processor 107 coupled to the display 106 controls content displayed on the display. The processor 107 and other components within the user device 105 are powered by a battery (not shown), which may be recharged by an external power source (also not shown), or alternatively may be powered by the external power source. A memory 108 coupled to the processor 107 may store or buffer video content for playback by the processor 107 and display on the display 106, and may also store a video player application (or “app”) 109 for performing such video playback. The video content being played may be received, either contemporaneously (e.g., overlapping in time) with the playback of the video content or prior to the playback, via transceiver 110 connected to antenna 111. As described above, the video content may be received in wireless communications from a base station 104. In the exemplary embodiment, the video content received by mobile device 105 for playback therein and display on display 106 includes display adaptation information embedded within NALU header(s). The display adaptation information is employed by processor 107 to set display controls 112 for the optional luminance source and display 106.

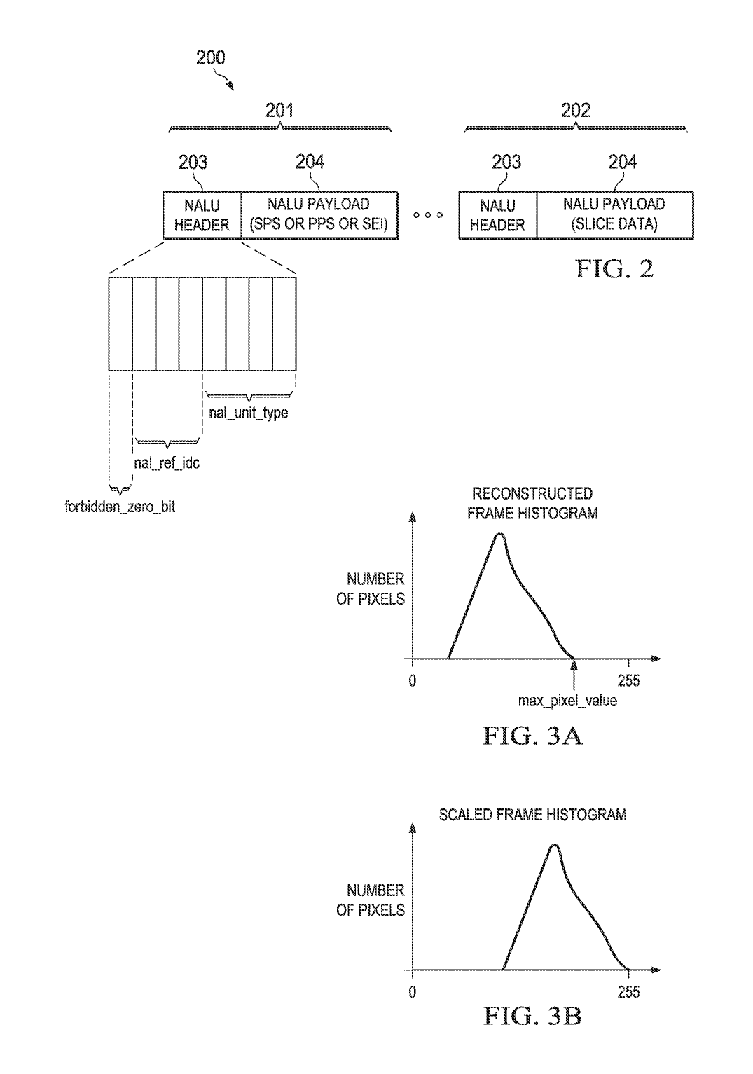

FIG. 2 is a diagram illustrating NALU headers within which may be embedded display adaptation information used for dynamic, content-based display adaptation and corresponding power reduction according to one embodiment of the present disclosure. Typically, a NALU 201, 202 within a data bitstream 200 consists of two parts, including the NALU header 203 and the payload 204. The NALU header 203 will be parsed at the decoder for appropriate decoding operations. For example, if the NALU header 203 indicates that that current NALU 201 is a sequence parameter set (SPS), then SPS parsing and initialization will be activated; alternatively, if the NALU 203 header indicates that the current NALU 202 is a slice NALU, then the slice decoding is launched.

In International Telecommunication Union (ITU) Telecommunication Standardization Section (ITU-T) Video Coding Experts Group (VCEG) standard H.264 Advanced Video Coding (AVC, also referred to as Motion Picture Experts Group 4 Part 10 or “MPEG-4 Part 10”) and its extensions, each NALU 210, 202 is byte-aligned. The NALU header 202 is either 1 byte or 4 bytes, depending on whether the NALU is a regular single layer packet or a scalable packet. TABLE I below shows the NALU syntax and the corresponding parsing process for H.264/AVC and its extensions:

TABLE I

| nal_unit( NumBytesInNALunit ) { | | C | Descriptor |
|---|---|---|---|
| | forbidden_zero_bit | All | f(1) |
| | nal_ref_idc | All | u(2) |
| | nal_unit_type | All | u(5) |
| | NumBytesInRBSP = 0 | | |
| | nalUnitHeaderBytes = 1 | | |
| | if( nal_unit_type == 14 \|\| | | |
| | nal_unit_type = = 20 ){ | | |

| | | |
|---|---|---|
| svc_extension_flag | All | u(1) |
| if( svc_extension_flag ) | | |
| nal_unit_header_svc_extension( ) /* | All | |

specified in Annex G */

| | |
|---|---|
| else | |
| nal_unit_header_svc_extension( )/* | All |

specified in Annex H */

nal_unitHeaderBytes += 3

}
for( i=nalUnitHeaderBytes;
i<NumBytesInNALunit;i++){

if( i+2<NumBytesInNALunit &&
next_bits(24) ==0x000003){

| | | |
|---|---|---|
| rbsp_byte[ NumBytesInRBSP++ ] | All | b(8) |
| rbsp_byte[ NumBytesInRBSP++ ] | All | b(8) |
| i += 2 | | |
| emulation_prevention_three_byte /* | All | f(8) |
| equal to 0x03 */ | | |

} else

| | | |
|---|---|---|
| rbsp_byte[ NumBytesInRBSP++ ] | All | b(8) |

}

}

As illustrated in FIG. 2, a normal 1-byte NALU header includes the 1-bit forbidden zero bit (always zero), a 3 bits nal_ref_idc field indicating whether the respective NALU can be referred, and 5 bits nal_unit_type field indicating the exact type of the NAL unit payload follows. If nal_unit_type equals to 14 or 20, an extra three bytes are parsed to derive the necessary information for H.264 scalable video. TABLE II below shows the nal_unit_type definitions in H.264/AVC:

TABLE II

| | | | | Annex G |
|---|---|---|---|---|
| | | | | and |
| nal_{—} | | | Annex A | Annex H |
| unit_{—} | Content of NAL unit and RBSP syntax | | NAL unit | NAL unit |
| type | structure | C | type class | type class |
| 0 | Unspecified | | non-VCL | non-VCL |
| 1 | Coded slice of a non-IDR picture | 2, 3, 4 | VCL | VCL |
| | slice_layer_without_partitioning_rbsp( ) | | | |
| 2 | Coded slice data partition A | 2 | VCL | not |
| | slice_data_partition_a_layer_rbsp( ) | | | applicable |
| 3 | Coded slice data partition B | 3 | VCL | not |
| | slice_data_partition_b_layer_rbsp( ) | | | applicable |
| 4 | Coded slice data partition C | 4 | VCL | not |
| | slice_data_partition_c_layer_rbsp( ) | | | applicable |
| 5 | Coded slice of a IDR picture | 2, 3 | non-VCL | VCL |
| | slice_layer_without_partitioning_rbsp( ) | | | |
| 6 | Supplemental enhancement information | 5 | non-VCL | non-VCL |
| | (SEI) | | | |
| | sei_rbsp( ) | | | |
| 7 | Sequence parameter set | 0 | non-VCL | non-VCL |
| | seq_parameter_set_rbsp( ) | | | |
| 8 | Picture parameter set | 1 | non-VCL | non-VCL |
| | pic_parameter_set_rbsp( ) | | | |
| 9 | Access unit delimiter | 6 | non-VCL | non-VCL |
| | access_unit_delimiter_rbsp( ) | | | |
| 10 | End of sequence | 7 | non-VCL | non-VCL |
| | end_of_seq_rbsp( ) | | | |
| 11 | End of stream | 8 | non-VCL | non-VCL |
| | end_of_stream_rbsp( ) | | | |
| 12 | Filler data | 9 | non-VCL | non-VCL |
| | filler_data_rbsp( ) | | | |
| 13 | Sequence parameter set extension | 10 | non-VCL | non-VCL |
| | seq_parameter_set_extension_rbsp( ) | | | |
| 14 | Prefix NAL unit | 2 | non-VCL | suffix |
| | prefix_nal_unit_rbsp( ) | | | dependent |
| 15 | Subset sequence parameter set | 0 | non-VCL | non-VCL |
| | subset_seq_parameter_set_rbsp( ) | | | |
| 16 . . . 18 | Reserved | | non-VCL | non-VCL |
| 19 | Coded slice of an auxiliary coded | 2, 3, 4 | non-VCL | non-VCL |
| | picture without partitioning | | | |
| | slice_layer_without_partitioning_rbsp( ) | | | |
| 20 | Coded slice extension | 2, 3, 4 | non-VCL | VCL |
| | slice_layer_extension_rbsp( ) | | | |
| 21 . . . 23 | Reserved | | non-VCL | non-VCL |
| 24 . . . 31 | Unspecified | | non-VCL | non-VCL |

Video Coding Layer (VCL) NALUs consist of the video data, slice layer or below; non-VCL information like sequence parameter sets, picture parameter sets, Supplemental Enhancement Information (SEI), etc. may also be provided via a NALU.

As shown in TABLE II, H.264/AVC defines various nal_unit_type values for appropriate parsing and decoding, with values 24 through 31 left unspecified. Accordingly, a new nal_unit_type=25 is introduced indicating the display adaptation associated information. (The choice of nal_unit_type=25 is merely for the purposes of illustration in this example; any of the “unspecified” nal_unit_type values could be used instead). Once nal_unit_type=25, the command display_adaptation( ) is used to parse and initialize the display adaptation associated data and structure. Each time this nal_unit_type is encountered, the decoder parses the respective NALU header and enables the frame-level, GOP-level, scene-level or time interval-level adaptation. As shown in TABLES III and IV below, the current definition of the NALU header is modified by extension to support embedding of display adaptation related information. TABLE III shows the extended NALU syntax and the corresponding parsing process for H.264/AVC and its extensions (modifications over TABLE I shown in italics in TABLE III):

TABLE III

| nal_unit( NumBytesInNALunit ) { | | C | Descriptor |
|---|---|---|---|
| | forbidden_zero_bit | All | f(1) |
| | nal_ref_idc | All | u(2) |
| | nal_unit_type | All | u(5) |
| | NumBytesInRBSP = 0 | | |
| | nalUnitHeaderBytes = 1 | | |
| | if( nal_unit_type == 14 \|\| | | |
| | nal_unit_type = = 20 ){ | | |

| | | |
|---|---|---|
| svc_extension_flag | All | u(1) |
| if( svc_extension_flag ) | | |
| nal_unit_header_svc_extension( ) /* | All | |

specified in Annex G */

| | |
|---|---|
| Else | |
| nal_unit_header_svc_extension( )/* | All |

specified in Annex H */

nal_unitHeaderBytes += 3

}
if(nal_unit_type == 25){

| | |
|---|---|
| display_scaling_method | f(4) |
| distortion_percentage | f(7) |

if(display=scaling_method ==
BRIGHTNESS_PRESERVED){

| | |
|---|---|
| max_pixel_value | f(8) |

} else if(display=scaling_method ==
CONTRAST_PRESERVED){

| | |
|---|---|
| max_pixel_value | f(8) |
| min_pixel_value | f(8) |

} else if(display=scaling_method ==
PERCEPTUAL_LOSSLESS){

| | |
|---|---|
| pixel_hist_stepsize | f(8) |
| max_pixel_value | f(8) |
| min_pixel_value | f(8) |

}
for( i=nalUnitHeaderBytes;
i<NumBytesInNALunit;i++){

if( i+2<NumBytesInNALunit &&
next_bits(24) ==0x000003){

| | | |
|---|---|---|
| rbsp_byte[ NumBytesInRBSP++ ] | All | b(8) |
| rbsp_byte[ NumBytesInRBSP++ ] | All | b(8) |
| i += 2 | | |
| emulation_prevention_three_byte /* | All | f(8) |
| equal to 0x03 */ | | |

} else

| | | |
|---|---|---|
| rbsp_byte[ NumBytesInRBSP++ ] | All | b(8) |

}

}

The tolerable distortion (“distortion_percentage”) is used for saturation purposes as described in further detail below. TABLE IV shows the extended nal_unit_type definitions in H.264/AVC (modifications over TABLE II shown in italics in TABLE IV):

TABLE IV

| | | | | Annex G |
|---|---|---|---|---|
| | | | | and |
| nal_{—} | | | Annex A | Annex H |
| unit_{—} | Content of NAL unit and RBSP syntax | | NAL unit | NAL unit |
| type | structure | C | type class | type class |
| 0 | Unspecified | | non-VCL | non-VCL |
| 1 | Coded slice of a non-IDR picture | 2, 3, 4 | VCL | VCL |
| | slice_layer_without_partitioning_rbsp( ) | | | |
| 2 | Coded slice data partition A | 2 | VCL | not |
| | slice_data_partition_a_layer_rbsp( ) | | | applicable |
| 3 | Coded slice data partition B | 3 | VCL | not |
| | slice_data_partition_b_layer_rbsp( ) | | | applicable |
| 4 | Coded slice data partition C | 4 | VCL | not |
| | slice_data_partition_c_layer rbsp( ) | | | applicable |
| 5 | Coded slice of a IDR picture | 2, 3 | non-VCL | VCL |
| | slice_layer_without_partitioning_rbsp( ) | | | |
| 6 | Supplemental enhancement information | 5 | non-VCL | non-VCL |
| | (SEI) | | | |
| | sei_rbsp( ) | | | |
| 7 | Sequence parameter set | 0 | non-VCL | non-VCL |
| | seq_parameter_set_rbsp( ) | | | |
| 8 | Picture parameter set | 1 | non-VCL | non-VCL |
| | pic_parameter_set_rbsp( ) | | | |
| 9 | Access unit delimiter | 6 | non-VCL | non-VCL |
| | access_unit_delimiter_rbsp( ) | | | |
| 10 | End of sequence | 7 | non-VCL | non-VCL |
| | end_of_seq_rbsp( ) | | | |
| 11 | End of stream | 8 | non-VCL | non-VCL |
| | end_of_stream_rbsp( ) | | | |
| 12 | Filler data | 9 | non-VCL | non-VCL |
| | filler_data_rbsp( ) | | | |
| 13 | Sequence parameter set extension | 10 | non-VCL | non-VCL |
| | seq_parameter_set_extension_rbsp( ) | | | |
| 14 | Prefix NAL unit | 2 | non-VCL | suffix |
| | prefix_nal_unit_rbsp( ) | | | dependent |
| 15 | Subset sequence parameter set | 0 | non-VCL | non-VCL |
| | subset_seq_parameter_set_rbsp( ) | | | |
| 16 . . . 18 | Reserved | | non-VCL | non-VCL |
| 19 | Coded slice of an auxiliary coded | 2, 3, 4 | non-VCL | non-VCL |
| | picture without partitioning | | | |
| | slice_layer_without_partitioning_rbsp( ) | | | |
| 20 | Coded slice extension | 2, 3, 4 | non-VCL | VCL |
| | slice_layer_extension_rbsp( ) | | | |
| 21 . . . 23 | Reserved | | non-VCL | non-VCL |
| 24 | Unspecified | | non-VCL | non-VCL |
| 25 | Display adaptation | | non-VCL | non-VCL |
| | Display_adaptation( ) | | | |
| 26 . . . 31 | Unspecified | | non-VCL | non-VCL |

As evident from TABLES III and IV, three different types of display adaptation (“display_scaling_method”) are contemplated: display adaptation preserving brightness of the pixels (“BRIGHTNESS_PRESERVED”); display adaptation preserving contrast (“CONTRAST_PRESERVED”); and perceptually lossless display adaptation (“PERCEPTUAL_LOSSLESS”). Display adaptation preserving brightness takes a single value as a parameter: the maximum pixel brightness value (“max_pixel_value”) within a histogram of pixel brightness values for a reconstructed frame encoded with the respective NALU header. Display adaptation preserving contrast rightness takes as parameter both the maximum pixel brightness value and the minimum pixel brightness value (“min_pixel_value”) within the histogram of pixel brightness values for the reconstructed frame. Perceptually lossless display adaptation, preserving both brightness and contrast, takes three parameters: the maximum and minimum pixel brightness values (“max_pixel_value”) within the histogram and the step size (“pixel_hist_stepsize”) of pixel brightness values used in generating the histogram.

In ITU VCEG and International Standards Organization (ISO)/International Electro-technical Commission (IEC) Motion Pictures Expert Group (MPEG) Joint Collaborative Team on Video Coding (JCT-VC) standard H.265 High Efficiency Video Coding (HVEC), the byte stream framework remains the same (i.e., NAL units are employed), but the NAL unit header is longer (and not compatible to H.264), new NAL unit types are introduced and several type number changes are made, and a modified NALU payload syntax is employed (that is also not H.264-compliant). Nonetheless, those skilled in the art will understand how the above-described techniques may be readily adapted for use with HVEC streams.

FIGS. 3A and 3B illustrate display adaptation preserving brightness using display adaptation information embedded within NALU headers for dynamic, content-based display adaptation and corresponding power reduction according to one embodiment of the present disclosure. Before decoding every frame, the extended NALU header message is parsed to extract the maximum pixel value used to scale up a current reconstructed frame by (255/max_pixel_value). Let p(i) indicate the original brightness of an i-th pixel value (in raster scan order) in a histogram of pixel brightness for a reconstructed frame as illustrated in FIG. 3A, then the scaled pixel brightness pnew(i) for that pixel in the scaled frame histogram illustrated in FIG. 3B is (for 8-bit pixel brightness values):

pnew(i)=p(i)*(255/maxpixelvalue), (1)

where max_pixel_value is the parameter specified in the extended NALU header as described above. As apparent by comparison on FIGS. 3A and 3B, the histogram is shifted by linear scaling.

Meanwhile, by increasing the pixel brightness, a lower brightness backlighting (for LCD displays) or a lower supply voltage (for OLED displays) may be used for a net reduction in energy. That is, for LCD displays the scaled pixel brightness is employed together with a reduced backlighting brightness. The scaled value may be set at the ratio (max_pixel_value/255)*100%. That is, the scaled backlighting brightness bnew is:

bnew=b*(maxpixelvalue/255), (2)

where b is the original backlighting brightness, and the scaled supply voltage is:

Vnew=V*(maxpixelvalue/255), (3)

where V is the original supply voltage. To further reduce energy, the maximum pixel value may be further altered to allow some pixel distortion (i.e., saturated after scaling), but without any perceptual difference, i.e.,

max_pixel_value=(1−distortion_percentage)*max_pixel_value. (4)

The parameter min_pixel_value may be similarly employed, together with max_pixel_value, for adaptation when scaling in CONTRAST_PRESERVED mode. The range between maximum and minimum pixel brightness may both be adjusted to maintain contrast. Likewise, the parameters min_pixel_value and pixel_hist_stepsize, together with max_pixel_value, for adaptation when scaling in CONTRAST_PRESERVED mode. The range between maximum and minimum pixel brightness and the distribution of pixel brightness may all be adjusted. While linear scaling of backlight brightness and supply voltage are assumed above, in actual implementations the scaling could be non-linear. Either linear or non-linear adjustment may be implemented through a look-up table, which may be constructed by measuring the display power at different levels of the backlight brightness or supply voltage.

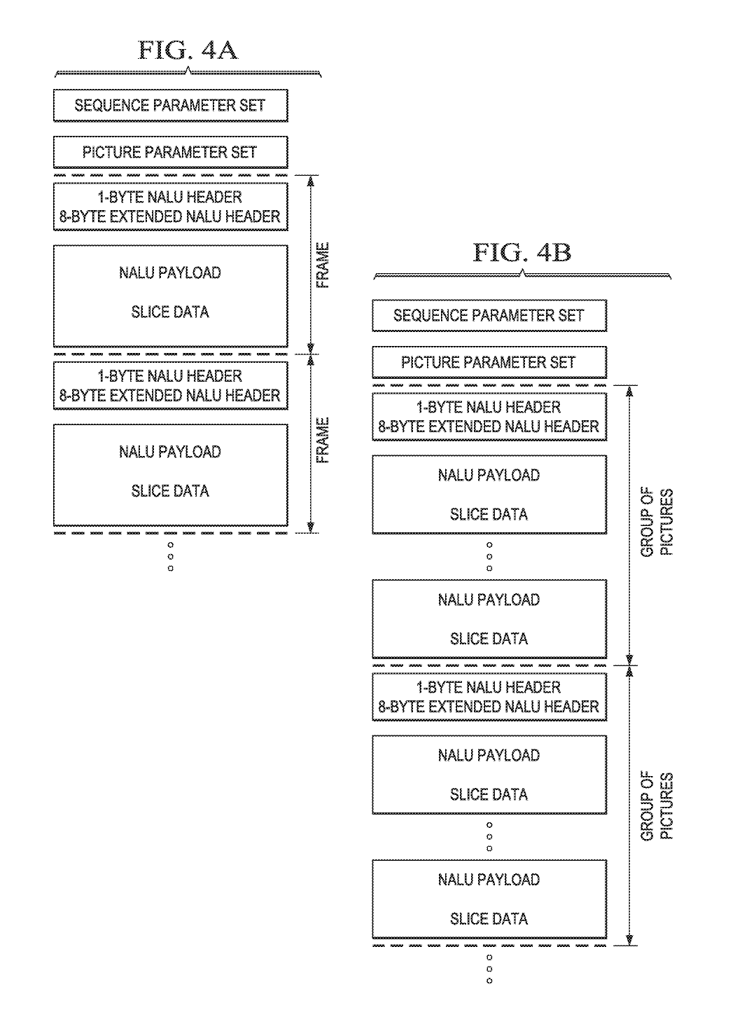

FIGS. 4A and 4B illustrate extended NALU header insertion within a video data bitstream for dynamic, content-based display adaptation and corresponding power reduction according to one embodiment of the present disclosure. FIG. 4A illustrates frame-based extended NALU header insertion, while FIG. 4B illustrates GOP-based extended NALU header insertion. Similar insertion schemes may be employed for scene-based or time interval-based extended NALU header insertion.

For LCD displays with separate backlighting of each of the red (R), green (G) and blue (B) color channels, pixel brightness scaling and backlighting brightness reduction as described above may be implemented separately for the pixel and backlighting brightness of each of the RGB colors individually. To the extent that separate supply voltages are employed for red, green and blue LEDs within an OLED display, pixel brightness scaling and supply voltage reduction as described above may be implemented separately for each RGB color. In that manner, different color components may be individually adapted.

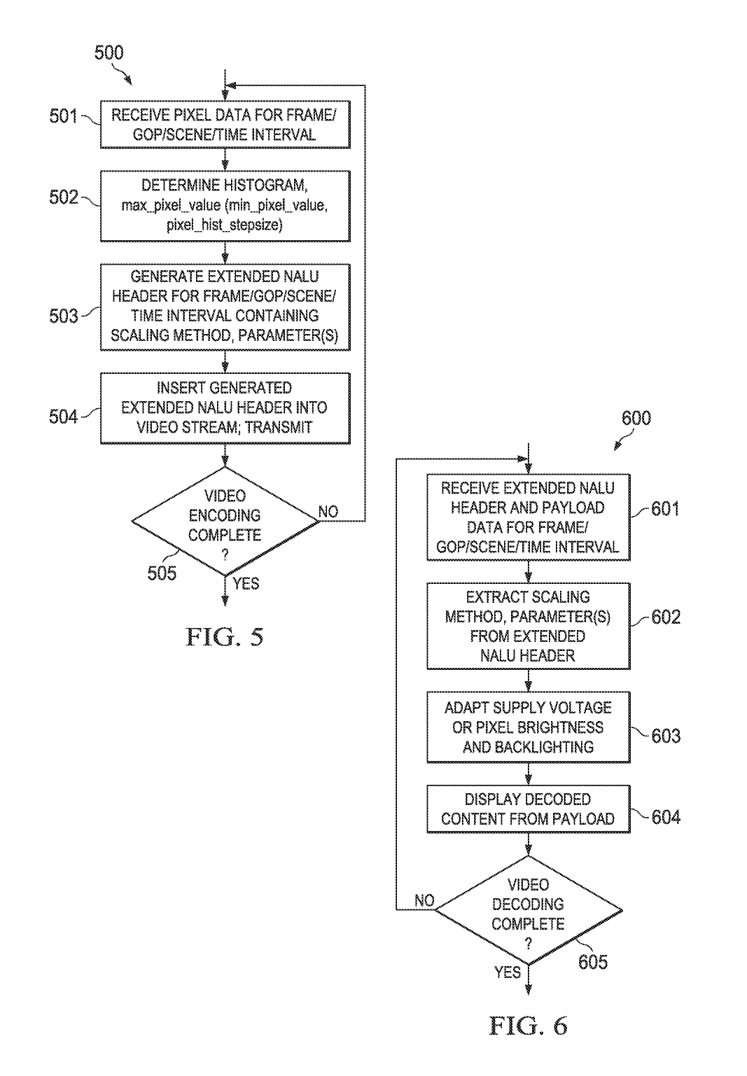

FIG. 5 is a high level flow diagram for a process of encoding video using extended NALU header insertion for dynamic, content-based display adaptation and corresponding power reduction according to one embodiment of the present disclosure. The process is performed by the encoder controller within encoder 101. The same process may be employed for encoding video regardless of whether intended for delivery to a device supporting display adaptation, since devices not supporting display adaptation may simply ignore display adaptation information embedded in the extended NALU headers. The process 500 begins with receiving pixel data for a frame, GOP, scene or time interval segment of the video being encoded (step 501).

The histogram of pixel brightness is determined for the video data of the segment being processed (step 502), including determination of at least max_pixel_value, and optionally also min_pixel_value and pixel_hist_stepsize. An extended NALU header is generated for the segment of video data being processed (step 503), with the scaling method and appropriate parameters included. The extended NALU header is then inserted into the payload stream in association with the corresponding segment data, and the encoded video data is transmitted (step 504). If the video encoding is incomplete (step 505), another iteration of the process is performed for the pixel data for the next frame, GOP, scene or time interval segment of the video being encoded.

FIG. 6 is a high level flow diagram for a process of video decoding and display based on extended NALU headers inserted for dynamic, content-based display adaptation and corresponding power reduction according to one embodiment of the present disclosure. The process is performed by user equipment 105. The process 600 begins with receiving an extended NALU header and associated payload for a frame, GOP, scene or time interval segment of the video being decoded (step 601). The scaling method and parameter(s) are extracted from the extended NALU header (step 602), and the pixel brightness and the supply voltage is adapted (for an OLED display) or the pixel and backlighting brightness are adapted (for an LCD display) based on the scaling method and parameter(s) (step 603). The video content decoded from the payload for the corresponding frame, GOP, scene or time interval segment is displayed with the adapted display settings (step 604). If the video decoding is incomplete (step 605), another iteration of the process is performed for the next frame, GOP, scene or time interval segment of the video being decoded.

Display adaptation using an extended NAL unit header message based on a brightness preserved algorithm is exemplified in the above disclosure. Such an algorithm requires the maximum pixel value to remain the same as in the embedded information. However, the principles disclosed are not limited to only such implementation. In another embodiment, any information derived from the video encoder may be embedded as part of the extended NALU header to help the display adaptation, such as both minimum and maximum pixel brightness values, or even the histogram distribution.

The present disclosure will make products, such as smartphones and tablets, much more power efficient while reducing the data cost, thus improving the user experience for mobile streaming applications.

While each process flow and/or signal sequence depicted in the figures and described above depicts a sequence of steps and/or signals, either in series or in tandem, unless explicitly stated or otherwise self-evident (e.g., a signal cannot be received before being transmitted) no inference should be drawn from that sequence regarding specific order of performance, performance of steps or portions or transmission of signals thereof serially rather than concurrently or in an overlapping manner, or performance the steps or transmission of signals depicted exclusively without the occurrence of intervening or intermediate steps or signals. Moreover, those skilled in the art will recognize that complete processes and signal sequences are not illustrated or described. Instead, for simplicity and clarity, only so much of the respective processes and signal sequences as is unique to the present disclosure or necessary for an understanding of the present disclosure is depicted and described.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method, comprising:
receiving data for a video segment, the received data including an extended header containing display adaptation information for adapting one or more display parameters affecting display brightness and power consumption; and
during display of the video segment, adapting at least one display parameter for a display based upon the display adaptation information from the extended header.

2. The method according to claim 1, wherein the display adaptation information comprises one or more of a maximum pixel brightness value, a minimum pixel brightness value and a pixel brightness histogram step size value.

3. The method according to claim 1, further comprising:
scaling pixel brightness for pixels and backlighting brightness based on a maximum pixel brightness value from the display adaptation information during display of the video segment on a backlit liquid crystal display (LCD).

4. The method according to claim 3, further comprising:
scaling the pixel brightness and the backlighting brightness based on the maximum pixel brightness value and a minimum pixel brightness value from the display adaptation information during display of the video segment on the backlit LCD.

5. The method according to claim 4, further comprising:
scaling the pixel brightness and the backlighting brightness based on the maximum pixel brightness value, the minimum pixel brightness value, and a pixel histogram step size value from the display adaptation information during display of the video segment on the LCD.

6. The method according to claim 1, wherein the display adaptation information comprises an identifier indicating a scaling method selected from a scaling method preserving brightness, a scaling method preserving contrast, and a perceptually lossless scaling method.

7. The method according to claim 1, further comprising:
scaling a supply voltage based on a maximum pixel brightness value from the display adaptation information during display of the video segment on an organic light emitting diode (OLED) display.

8. A system, comprising:
a receiver configured to receive data for a video segment, the received data including an extended header containing display adaptation information for adapting one or more display parameters affecting display brightness and power consumption; and
a processor configured, during display of the video segment, to adapt at least one display parameter for a display based upon the display adaptation information from the extended header.

9. The system according to claim 8, wherein the display adaptation information comprises one or more of a maximum pixel brightness value, a minimum pixel brightness value and a pixel brightness histogram step size value.

10. The system according to claim 8, wherein the processor is configured to scale pixel brightness for pixels and backlighting brightness based on a maximum pixel brightness value from the display adaptation information during display of the video segment on a backlit liquid crystal display (LCD).

11. The system according to claim 10, wherein the processor is configured to scale the pixel brightness and the backlighting brightness based on the maximum pixel brightness value and a minimum pixel brightness value from the display adaptation information during display of the video segment on the backlit LCD.

12. The system according to claim 11, wherein the processor is configured to scale the pixel brightness and the backlighting brightness based on the maximum pixel brightness value, the minimum pixel brightness value, and a pixel histogram step size value from the display adaptation information during display of the video segment on the LCD.

13. The system according to claim 8, wherein the display adaptation information comprises an identifier indicating a scaling method selected from a scaling method preserving brightness, a scaling method preserving contrast, and a perceptually lossless scaling method.

14. The system according to claim 8, wherein the processor is configured to scale a supply voltage based on a maximum pixel brightness value from the display adaptation information during display of the video segment on an organic light emitting diode (OLED) display.

15. A mobile communications device including the system according to claim 8, wherein the system is configured to receive the data for the video segment in wireless communications from a base station.

16. A tablet including the system according to claim 8, wherein the system is configured to receive the data for the video segment in wireless communications from a network.

17. A method, comprising:
formatting data for a video segment for transmission, the formatted data including
an extended header containing display adaptation information for adapting one or more display parameters affecting display brightness and power consumption, and
one or more payload units containing data for displaying the video segment.

18. The method according to claim 17, wherein the display adaptation information comprises one or more of a maximum pixel brightness value, a minimum pixel brightness value and a pixel brightness histogram step size value.

19. The method according to claim 17, wherein the display adaptation information comprises an identifier indicating a scaling method selected from a scaling method preserving brightness, a scaling method preserving contrast, and a perceptually lossless scaling method.

20. A system, comprising:
a video server configured to format data for a video segment for transmission, the formatted data including
an extended header containing display adaptation information for adapting one or more display parameters affecting display brightness and power consumption, and
one or more payload units containing data for displaying the video segment.

21. The system according to claim 20, wherein the display adaptation information comprises one or more of a maximum pixel brightness value, a minimum pixel brightness value and a pixel brightness histogram step size value.

22. The system according to claim 20, wherein the display adaptation information comprises an identifier indicating a scaling method selected from a scaling method preserving brightness, a scaling method preserving contrast, and a perceptually lossless scaling method.

23. A method, comprising:
receiving data for a video segment for transmission, the data including
an extended header containing display adaptation information for adapting one or more display parameters affecting display brightness and power consumption, and
one or more payload units containing data for displaying the video segment; and
transmitting the data to a device on which the video segment is to be displayed.

24. The method according to claim 23, wherein the display adaptation information comprises one or more of a maximum pixel brightness value, a minimum pixel brightness value and a pixel brightness histogram step size value.

25. The method according to claim 23, wherein the display adaptation information comprises an identifier indicating a scaling method selected from a scaling method preserving brightness, a scaling method preserving contrast, and a perceptually lossless scaling method.
